(19) United States
(12) Patent Application Publication
(10) Pub. No.: US 2024/0377137 A1
(43) Pub. Date: Nov. 14, 2024

(54) SYSTEMS AND METHODS TO EVALUATE SPRAY COOLING COVERAGE OF GRAPHITE FURNACE ELECTRODES

(71) Applicant: CHEMTREAT, INC., Glen Allen, VA (US)

(72) Inventors: Robert JEFFERS, Glen Allen, VA (US); Alan J. FELLER, Macy, IN (US); James R. LAWSON, Louisville, TN (US); Jeremy LEITZE, Avon, IN (US)

(73) Assignee: CHEMTREAT, INC., Glen Allen, VA (US)

(21) Appl. No.: 18/657,044

(22) Filed: May 7, 2024

Related U.S. Application Data
(60) Provisional application No. 63/464,710, filed on May 8, 2023.

(51) Int. Cl. F27D 21/02; F27D 9/00; F27D 11/00

(52) U.S. Cl. CPC F27D 21/02; F27D 11/00; F27D 2009/0016; F27D 2021/026

(57) ABSTRACT

Methods and systems are described for evaluating the coverage of cooling water that is sprayed onto the surface of a graphite furnace electrode. The surface of the electrode can be sprayed with cooling water that includes an additive, and the sprayed surface can be visually inspected or imaged to assess the cooling water coverage of the electrode surface. One or more corrective measures can be taken to improve the spray coverage if it is deemed to be inadequate.

### CROSS-REFERENCE TO RELATED APPLICATIONS

This application claims the earlier filing date benefit of U.S. Provisional Application No. 63/464,710, filed on May 8, 2023, the entirety of which is incorporated by reference herein.

### TECHNICAL FIELD

This disclosure relates generally to techniques for evaluating spray cooling water coverage that is sprayed onto furnace electrodes used in a furnace (e.g., an electric arc furnace (EAF) or ladle metallurgy furnace (LMF)), and more specifically to identifying deficiencies or inadequacies in the spray cooling water system so that corrective maintenance can be performed to reduce sidewall oxidation losses.

### BACKGROUND

EAF steel producers use electrical energy to melt raw materials to produce 1 ton to 420 metric tons of steel in vessels. Electrical energy can be delivered to the furnace(s) as alternating current (AC) or direct current (DC). The electrical power delivered to the raw materials can be as high as 200 MWh in the case of the largest EAF vessels. This power supply creates an electrical arc that creates the necessary heat to raise the batch of steel to temperatures as high as 1800° C. and to allow for further refinement and processing in the LMF and subsequent casting and forming operations.

The electrical power is delivered to the steel through graphite electrodes. Graphite is the material of choice for electrodes due to the following characteristics: low coefficient of thermal expansion (CTE), high tensile strength, high specific resistance, electrical resistance that is relatively independent of temperature, and nobility (cathodic to other materials).

Electrodes are consumables utilized in the electrical steel making process and account for a substantial cost for the steel maker. The environment in the electric arc furnace is violent and harsh, and causes consumption of electrodes in a range of approximately 0.8 kg/metric ton of steel produced to 2.5 kg/metric ton. Causes of consumption include: electrical arc at the electrode tip where localized temperature is approximately 3000° C.; electrode breakage due to movement of raw materials; thermal shock and subsequent loss of electrode tip; and oxidation of the electrode surfaces along the column due to the harsh furnace environment. Oxidation of the electrode creates the conical shape of electrodes that are in use and can account for nearly 50% of the electrode consumption.

For decades, steel producers and furnace electrode producers have attempted to reduce the oxidation rate of the graphite and carbon electrodes through many different means. One example is to use electrodes that have surfaces coated with layers formed from graphite, metal, aluminum alloys, and pure aluminum. However, these coatings are only applied once (e.g., only during the manufacturing of the electrodes), and the coatings are susceptible to chemical and physical damage that renders them ineffective. Thus, these types of coatings can have short useful life spans.

Changes in the electrode manufacturing process, in electrode coupling technology, in the recipe for the graphite electrodes, and in operational procedures like foamy slag have substantially reduced electrode consumption since 1985 when electrode consumption was between 5 to 6 kg/metric ton of steel, to 0.8 to 2.5 kg/metric ton of steel in 2018. While this has been an impressive reduction, market forces have heightened sensitivity to the consumption rate. Even incremental decreases in consumption rate have a substantial impact to the steel maker.

The oxidation of the electrode is a chemical reaction. The rate of oxidation of the electrode increases with increasing temperatures because the reactant molecules have more kinetic energy at higher temperatures. The reaction rate (i.e., oxidation rate) is governed by the Arrhenius equation which in almost all cases shows an exponential increase in the rate of reaction as a function of temperature.

$$k = \frac{- Ea}{{k}_{B} T}$$

Where: k=the rate constant
   k_{B}=Boltzmann constant
   T=absolute temperature
   A=a constant for each chemical reaction
   Eₐ=the activation energy
   R=the universal gas constant

Therefore, many designs have been developed to cool the bulk of the electrode (i.e., lower the temperature of the electrode), but have been abandoned due to safety concerns. Applying cooling water to the electrode below the molten steel bath creates a very dangerous condition in the case of an electrode break or the failure of the cooling water channel. The release of cooling water below the steel bath creates an explosion due to the rapid expansion as the water changes phase from water to steam with an approximate volumetric expansion of 1,100 times. Electrodes used in commercial steel making are currently composed exclusively of graphite and do not contain cooling water channels.

To further reduce oxidation of the electrode, spray cooling was introduced to the industry and specific designs were developed to cool the electrode using circular spray headers with multiple vertical spray headers located at multiple locations around the circumference of the electrode above the furnace. The use of spray cooling water to reduce electrode oxidation losses has been extensively adopted in the steel-making industry. In general, the positioning, operating conditions, and maintenance of the spray cooling system has been left to the judgment of the furnace operator. However, due to the extremely harsh environment, dark coloring of the electrodes and poor lighting that exists above the furnace, while the furnace electrode is in use and being sprayed with cooling water, it is very difficult for a furnace operator to visually confirm proper spray coverage or determine the proper maintenance frequency of the spray cooling ring.

### SUMMARY

This disclosure provides systems and methods for evaluating the spray coverage of a spray cooling water system to determine whether a corrective maintenance is needed to ensure proper spray coverage of the electrode surface. Accordingly, in one aspect, the invention described herein can even further decrease the oxidation rate of furnace electrodes by quickly detecting and correcting inadequacies or problems with the spray system.

The disclosure provides a method for evaluating a spray cooling system that is used with a graphite furnace electrode that can melt raw materials in a furnace. The method can include (i) adding and additive to spray cooling water to provide a chemically modified spray cooling water; (ii) spraying the chemically modified spray cooling water onto a surface of the graphite electrode with the spray cooling system; (iii) evaluating the surface of the graphite electrode that has been sprayed with the chemically modified cooling water to determine whether the spray cooling system sufficiently covers the surface with the chemically modified cooling water; and (iv) if it is determined that the chemically modified spray cooling water does not sufficiently cover the surface, taking at least one corrective action that changes the spray cooling system.

The disclosure can also provide a system for cooling a graphite furnace electrode that can melt raw materials in a furnace. The system can include (i) a spray header that is configured to spray the graphite furnace electrode with a chemically modified cooling water that includes an additive; (ii) at least one imaging unit that is arranged to image the surface of the graphite furnace electrode that has been sprayed with the chemically modified cooling water to provide image information of the surface; and (iii) a controller that receives the image information and is programmed to render at least one image of the surface that can be displayed on a display.

### BRIEF DESCRIPTION OF THE DRAWINGS

FIG. 1 is a schematic diagram illustrating a system for evaluating the spray cooling coverage of a furnace electrode according to one embodiment.

FIG. 2 is a schematic diagram illustrating a system for evaluating the spray cooling coverage of a furnace electrode according to another embodiment.

FIG. 3 is a schematic diagram illustrating a system for evaluating the spray cooling coverage of a furnace electrode according to yet another embodiment.

### DETAILED DESCRIPTION OF EMBODIMENTS

The disclosed methods and systems may be used to evaluate the spray coverage of a cooling system that is used for high-temperature graphite furnace electrodes and to facilitate one or more actions based on the evaluation that change the spray pattern or otherwise improve the spray coverage. As explained in detail below, aspects of the invention include adding an additive to the cooling water that facilitates visual confirmation of the spray coverage, evaluating the spray coverage on the furnace electrode once the cooling water has been sprayed on the electrode surface (e.g., by human visual confirmation, visual confirmation using a magnifying or imaging unit, or with a computer-programmed analysis of an image) imaging the furnace electrode once the cooling water has been sprayed on the electrode surface, and taking one or more corrective actions to correct or improve any non-uniform coverage areas that are identified.

As used herein “cooling water” refers to any liquid that is at least 95 wt. % water that is sprayed onto the surface of the furnace electrode, and this disclosure expressly contemplates that the cooling water can include additives that enhance the visibility or detectability of the spray pattern. The high-temperature graphite furnace electrodes can be those used in furnaces such as an electric arc furnace, induction furnace, vacuum induction melting, argon oxygen decarburization, ladle furnace, vacuum oxygen degassing, vacuum degassing, vacuum arc remelting, and electro slag remelting.

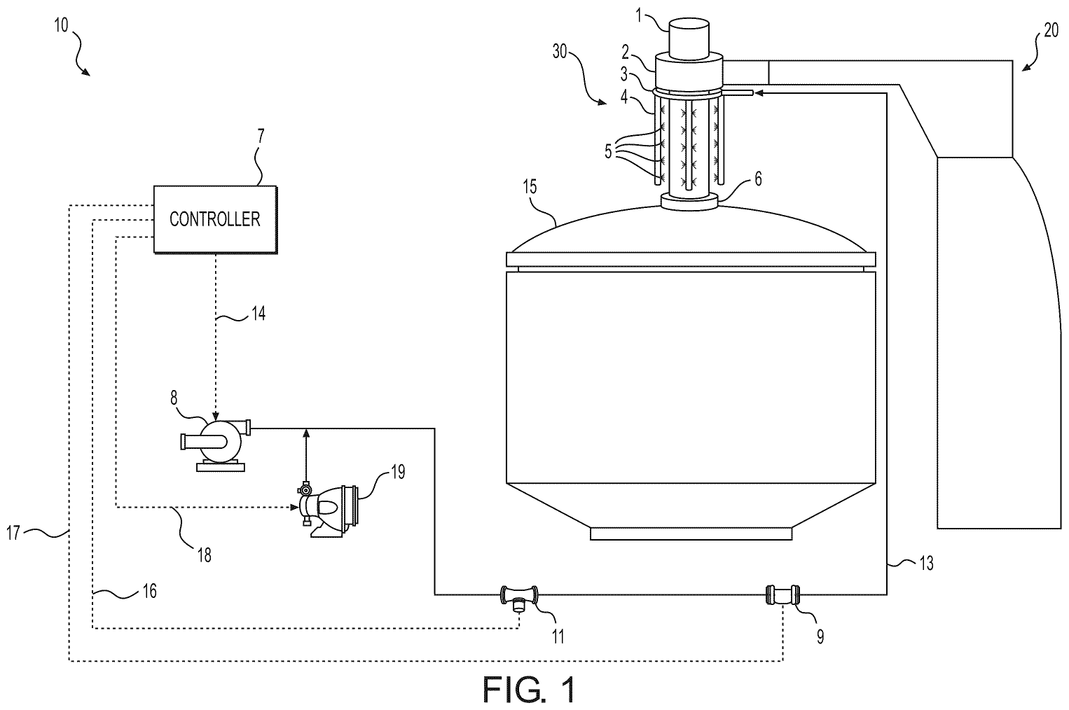

FIG. 1 illustrates a typical spray cooling water system 10 for a furnace electrode 1 for a direct current furnace 15. Similar cooling systems can also be used on multiple electrodes in alternating current furnaces. In system 10, an electrode holder 2 that is connected to electrode mast 20 holds a graphite electrode 1 which extends into the furnace 15 through the top of the furnace 6. The size of the graphite electrode 1 can typically vary from 75 mm to 700 mm in diameter, although electrodes of up to 800 mm are available. The cooling water can be pumped through flow path 13 via pump 8 (e.g., a booster pump) to the spray cooling header/arrangement 30. A control valve 9 can regulate the flow of spray cooling water to the header 30 based upon signal 17 from a controller 7, such as a distributed control system (DCS). An in-line flow meter 11 can measure the flow rate of cooling liquid in flow path 13 and send a signal 16 to the controller 7 that actuates a pump 8 (e.g., a booster pump) to control the supply of cooling water. The spray cooling header 30 (i.e., the cooling bank) has a circular ring distribution header 3 and a vertical spray distribution header 4. The vertical spray distribution header 4 includes a plurality of nozzles 5 from which the cooling water is sprayed onto the outer circumference of the electrode 1. In this manner, direct cooling of the electrode occurs from the electrode holder 2 to the top of the furnace 6.

In most facilities, the cooling water is constantly applied to the electrodes while the electrode is in use and receiving electric power to actively melt raw materials such as steel. Since the oxidation rate of graphite increases exponentially with temperature, the cooling water reduces the sidewall oxidation of the electrode by cooling the electrode during use. For this reason, the use of cooling water is most effective when the spray cooling water is sprayed in a consistent pattern that covers substantially all of the surface area of the electrode surface between the electrode holder 2 and the top of the furnace 6. For example, the spray pattern should preferably cover at least 75%, at least 85%, or at least 90% of the electrode surface area in this region.

However, during use of the furnace to melt raw materials, there are various factors that can cause inadequate coverage of the spray cooling water on the electrode surface. For example, the spray header arrangement, nozzle layout, impingement angle, and/or nozzle distance from the electrode surface might be inadvertently configured so that the sprayed water does not sufficiently cover the electrode surface. The cooling water flow rate or the cooling water pressure at the nozzles may also cause the spray pattern to be inadequate. Likewise, the nozzles may be defective or clogged due to material in the cooling spray water, or may be fouled due to solids from the steel melting process. However, for the reasons stated above, it can be very difficult for a furnace operator to visually identify these deficiencies.

According to one aspect of this disclosure, at least one additive can be added to the spray cooling water that enhances the visibility of the spray coverage on the electrode surface. For example, as shown in FIG. 1, the spray cooling water system 10 can include a chemical injection pump or chemical metering skid 19 that supplies a visual additive in-line with flow path 13. The cooling water with the additive is sometimes referred to herein as “chemically modified cooling water”. The controller 7 can control the addition of the additive by sending signals 18 to the dosing unit. In some aspects, the additive can be selected to form a visible coating on the electrode surface. For example, the additive can be dissolved and/or suspended in the cooling water and can form a coating on the hot electrode surface above the furnace when the chemically modified cooling water evaporates. Suitable additives and techniques for adding and controlling the addition of additives to the cooling water flow path 13 are described in detail in Applicant's U.S. Pat. No. 10,694,592, which is incorporated by reference herein in its entirety. Although this prior disclosure relates to forming an antioxidant barrier coating on the electrode surface, it has been discovered in connection with this invention, that the addition of additive(s) can be selected to form a coating that can also advantageously provide a clear indicator that makes the spray pattern readily identifiable, either by visual inspection or by aid of imaging or magnification. Furthermore, in addition or as an alternative to the additives specifically identified in U.S. Pat. No. 10,694,592, additives such as colorants, dyes, or pigments can be added to the cooling water that can provide an enhanced visual indicator that enables the spray coverage to be readily identified. Similarly, it may be useful to use cooling water additives that provide a measurable fluorescence signal or phosphorescence signal if an imaging unit is used with a suitable fluorescence or phosphorescence detector.

Whether done by a human eye, alone or with aid of a magnifying or imaging unit, or by computer analysis, the spray coverage of the electrode surface can be evaluated as cooling water that includes the additive is sprayed onto the hot electrode or possibly soon after spraying has stopped. The electrode surface can be evaluated when the electrode is positioned in the furnace and is actively melting raw materials, and when a portion of the electrode above the furnace is being sprayed with the cooling water. Evaluating the electrode surface for spray coverage while the electrode is in use melting raw materials allows for real-time feedback, which allows for quick corrective actions to be taken before any spray cooling inadequacies cause increased sidewall oxidation. The electrode surface can also be sprayed with the cooling water and evaluated during the dwell time of the furnace where electricity to the furnace electrode is turned off and the hot electrode is optionally withdrawn from the furnace (e.g., to advance the graphite electrode through the electrode holder). It may also be possible to evaluate the spray coverage when the electrode is offline, e.g., after use, but where the electrode is still hot by spraying the cooling water on the hot electrode surface.

Once problems with the spray coverage are identified, various corrective measures can be taken to improve the spray coverage. For example, the cooling water flow rate or cooling water pressure can be changed, the additive that is added to the cooling water can be changed, the amount of additive that is added to the cooling water can be changed, the spray geometry can be changed (e.g., by adjusting the nozzle layout, impingement angle, or spray configuration), the nozzles or distribution lines can be replaced, cleaned, unclogged, drilled out, and/or other components of the spray water system can be maintained.

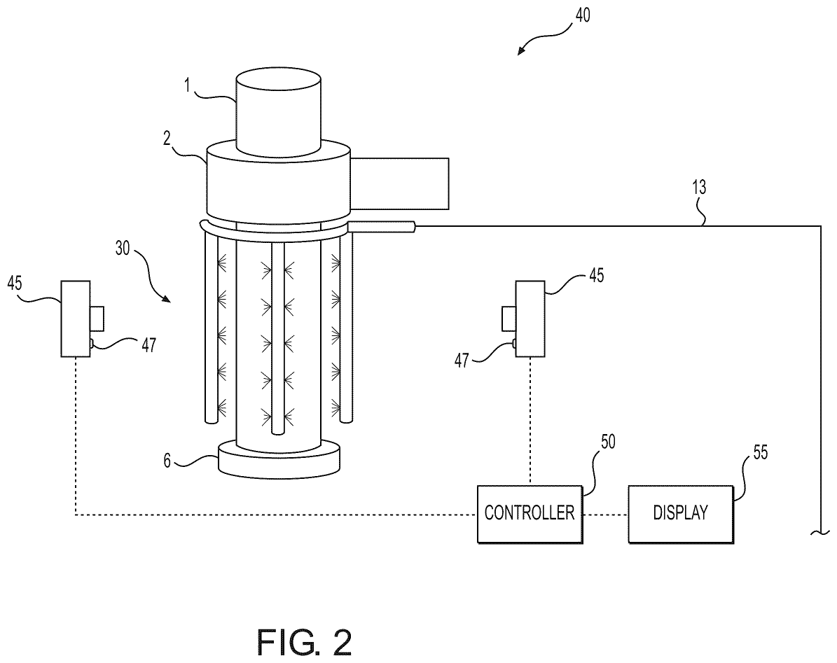

FIG. 2 illustrates a spray cooling water system 40 according to an embodiment of the invention that enables the cooling water spray pattern to be imaged, visually evaluated, and optionally corrected if needed. As in the FIG. 1 embodiment, the cooling water is combined with an additive that enhances the visibility or detectability of the spray coverage. The spray water header 30 is the same as in the FIG. 1 embodiment and is arranged to spray cooling water onto the surface of the furnace electrode 1 over the area between the electrode holder 2 and the top of the furnace 6. The spray cooling water system 40 includes one or more imaging units 45 that can capture images of the electrode outer surface that is in the spray region. The imaging unit can include, for example, an optical imaging unit such as a camera that captures or senses visible or not visible light (e.g., infrared or UV light) from the electrode surface. The imaging unit may be a digital camera, an infrared camera, a fluorescence detector, a phosphorescence detector, or the like, and can include a sensor such as a CCD image sensor (Charge Coupled Device), a CMOS image sensor (Complementary Metal Oxide Semiconductor), an InGaAs sensor (indium gallium arsenide), etc. A combination of these different types of imaging units may also be used, e.g., a digital camera can be used with an infrared camera, to provide multiple images of the electrode surface covering different regions of the electromagnetic spectrum.

Since the spray water includes an additive that enhances the visibility or detectability of the spray coverage, e.g., by forming a coating on the electrode surface, the images captured by the imaging unit 45 can show the spray coverage pattern on the surface of the electrode. For example, if the optical imaging unit captures visual light, the images can visibly show areas of the electrode surface that are being contacted with spray cooling water and areas that are not being contacted with spray cooling water or are receiving insufficient quantities of cooling water. Similarly, if the imaging unit includes an infrared camera, the images can show temperature variations on the surface of the electrode that can be used to confirm the visual spray coverage, e.g., where cooler areas may have adequate spray cooling water coverage and hotter areas may have inadequate spray cooling water coverage.

The system 40 can have a sufficient number of imaging units 45 so that most or all of the electrode surface between the electrode holder 2 and the top of the furnace 6 can be imaged. For example, the system 40 may include 1 to 8 imaging units, or from 2 to 6 imaging units for example, and the imaging units can be spaced around the outer perimeter of the furnace electrode 1. The imaging units 45 can be stably mounted relative to the electrode 1, e.g., such as being mounted on the electrode holder 2 or the electrode mast 20 (FIG. 1). The system 40 can optionally include one more light sources 47 that can illuminate the electrode surface to improve the image quality (shown in this embodiment as being integrated into imaging unit 45), particularly if the imaging unit 45 is configured to capture visible light that is reflected from the electrode surface. The imaging unit 45 can capture an image of the surface of furnace electrode 1 that shows a spray pattern. The imaging unit 45 can convey signals with image information to controller 50 via wired or wireless communication paths. The controller may include one or more processors such as a CPUs, that are programmed individually or collectively (e.g., with algorithms) to perform the functions described herein. The controller 50 may be programmed to render the captured image(s) of the electrode surface to be displayed on a display 55. In some embodiments, the controller 50 may be optionally programmed to analyze the captured images of the furnace electrode 1 to automatically identify regions of the electrode surface that have inadequate spray coverage, or possibly to quantify the amount of surface area that has inadequate coverage.

During use, the electrode surface can be regularly imaged or imaged at predetermined periods (e.g., at least once or twice per day). The electrode can be imaged while the electrode is electrified in use and melting raw materials, during the dwell time, or when the electrode is otherwise hot.

The controller 50 may also be programmed so that, once it identifies regions of inadequate spray coverage or once the regions exceed a predetermined threshold area, it can provide a diagnosis, alert, or guidance that can be displayed on display 55 that can help an operator take specific corrective measures. In other aspects, the controller 50 can be programmed to send control signals (e.g., to a DCS as in FIG. 1) that cause a parameter of the cooling water (e.g., cooling water pressure or flow rate or additive addition rate) to change in response to the evaluation of the image. In some embodiments, the image of the electrode surface can be displayed on display 55, and the operator can diagnose or identify any inadequacies in the cooling spray water coverage, and take any of the corrective measures identified above, based on the operator's experience and knowledge.

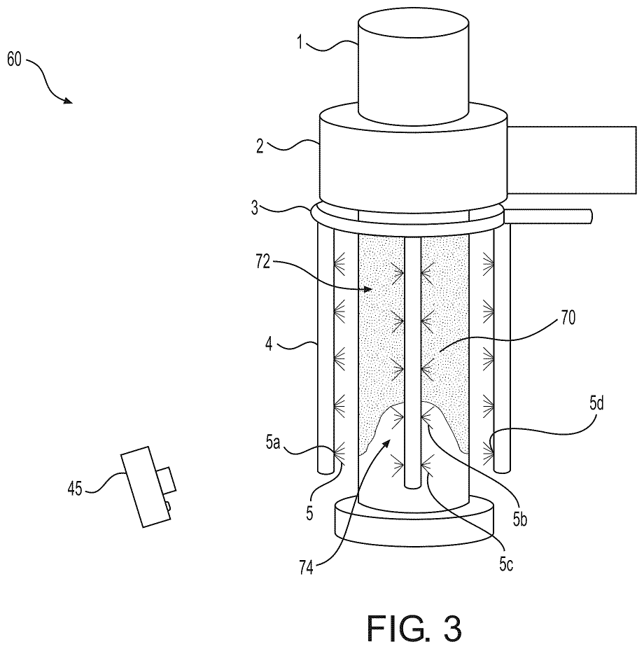

FIG. 3 illustrates an embodiment of a spray cooling water system 60 where the spray cooling water is combined with an additive that forms a visible coating on the surface of electrode 1. As can be seen in FIG. 3, the coating 70 is formed on the outer surface of electrode 1 as the cooling water is sprayed on the electrode surface. The coating 70 is visible and can be seen by an imaging unit 45 that captures visible light reflected from the electrode surface. The imaging unit 45 can also be a magnifying unit (e.g., a magnifying lens, binoculars, digital zoom, etc.) that magnifies the electrode surface for the operator to sec. Accordingly, by analyzing the electrode surface or an image of the electrode surface, either by an operator or by at least one processor (not shown in FIG. 3), it can be determined that the spray coverage of the spray cooling water system 60 is adequate in region 72 where the coating 70 appears, but is inadequate in region 74 where there is no visible coating. It may also be determined that the corrective action should be taken because the area of the region 74 exceeds a predetermined threshold (e.g., more than 10%, more than 20%, or more than 25% of the surface area between the electrode holder 2 and the top of the furnace 6). In the example of FIG. 3, the operator may conclude that nozzles 5a, 5b, 5c, and 5d are malfunctioning or are fouled, and corrective action can be taken such as drilling the nozzles.

Accordingly, aspects of the invention provide a visual indication of the cooling water coverage that is being applied to the electrode that allows problems in spray coverage to be diagnosed and addressed. Improving the spray coverage can significantly reduce sidewall oxidation of the furnace electrode, which reduces the cost of the electrodes (i.e., reduces the rate at which they are consumed during use), reduces carbon emissions associated with sidewall oxidation, and can improve the life of the furnace equipment.

It will be apparent to those skilled in the art that variations of the processes and systems described herein are possible and are intended to be encompassed within the scope of the present invention.

What is claimed is:

1. A method for evaluating a spray cooling system that is used with a graphite furnace electrode that can melt raw materials in a furnace, the method comprising:
(i) adding and additive to spray cooling water to provide a chemically modified spray cooling water;
(ii) spraying the chemically modified spray cooling water onto a surface of the graphite electrode with the spray cooling system;
(iii) evaluating the surface of the graphite electrode that has been sprayed with the chemically modified cooling water to determine whether the spray cooling system sufficiently covers the surface with the chemically modified cooling water; and
(iv) if it is determined that the chemically modified spray cooling water does not sufficiently cover the surface, taking at least one corrective action that changes the spray cooling system.

2. The method of claim 1, wherein the step of evaluating includes a visual inspection by a human.

3. The method of claim 1, further comprising imaging the surface of the graphite electrode that has been sprayed with the chemically modified cooling water to provide an image of the surface, and wherein the step of evaluating includes evaluating the image of the surface.

4. The method of claim 3, wherein the imaging comprises capturing an infrared image of the surface.

5. The method of claim 3, wherein the imaging comprises capturing a visible image of the surface.

6. The method of claim 1, wherein the additive forms a coating on the surface of the graphite electrode that is visible to the human eye once the modified cooling water is sprayed onto the surface.

7. The method of claim 3, wherein the imaging comprises taking images with a camera, a digital camera, an infrared camera, a fluorescence detector, a phosphorescence detector, or a sensor that captures light.

8. The method of claim 1, wherein the at least one corrective action increase the surface area of the graphite electrode over which the modified cooling water is sprayed.

9. The method of claim 1, wherein the at least one corrective action includes changing the geometry of a component of the spray cooling system, cleaning a component of the spray cooling system, rearranging a component of the spray cooling system, unclogging a component of the spray cooling system, drilling out a component of the spray cooling system, or replacing a component of the spray cooling system.

10. The method of claim 1, wherein the at least one corrective action includes adjusting the pressure of the modified cooling water that is sprayed onto the surface, changing the amount of the additive that is added to the cooling water, or adjusting the flow rate of the modified cooling water that is sprayed onto the surface.

11. A system for cooling a graphite furnace electrode that can melt raw materials in a furnace, the system comprising:
(i) a spray header that is configured to spray the graphite furnace electrode with a chemically modified cooling water that includes an additive;
(ii) at least one imaging unit that is arranged to image the surface of the graphite furnace electrode that has been sprayed with the chemically modified cooling water to provide image information of the surface; and
(iii) a controller that receives the image information and is programmed to render at least one image of the surface that can be displayed on a display.

12. The system of claim 10, wherein the controller is programmed to analyze the at least one image and identify any regions of the electrode surface where the chemically modified cooling water has not been adequately sprayed.
